(19) United States
(12) Patent Application Publication
(10) Pub. No.: US 2011/0222908 A1
(43) Pub. Date: Sep. 15, 2011

(54) Fixing device and image forming apparatus using the same

(75) Inventors: Sho Sawahata, Ibaraki (JP); Genichiro Kawamichi, Ibaraki (JP); Ken Onodera, Ibaraki (JP); Yuuki Kikushima, Ibaraki (JP); Ryuichi Sukegawa, Ibaraki (JP); Ryuuji Sakamoto, Ibaraki (JP); Yutaka Nagasawa, Ibaraki (JP); Soushi Kikuchi, Ibaraki (JP)

(73) Assignee: Ricoh Company, Ltd., Tokyo (JP)

(21) Appl. No.: 13/064,215

(22) Filed: Mar. 11, 2011

(30) Foreign Application Priority Data
Mar. 12, 2010 (JP) 2010-056694
Mar. 15, 2010 (JP) 2010-057671
Nov. 1, 2010 (JP) 2010-245370

(51) Int. Cl. G03G 15/00; G03G 21/00

(52) U.S. Cl. 399/159; 399/346

(57) ABSTRACT

A disclosed fixing device includes a first roller, a second roller, a lubricant application unit applying lubricant to a surface of the first roller, a lubricant control blade being in contact with and separated from the surface of the first roller, so that the recording medium on which the image is formed is sandwiched and fed between the first roller and the second roller so as to fix the image onto the recording medium, a contact angle θ of the lubricant control blade relative to the first roller is in a range between 35 degrees and 43 degrees, and a linear pressure F applied from the lubricant control blade to the first roller is in a range from 0.35 N/cm to 0.5 N/cm.

### CROSS-REFERENCE TO RELATED APPLICATIONS

The present application claims priority under 35 U.S.C §119 to Japanese Patent Application Nos. 2010-056694 filed on Mar. 12, 2010, 2010-057671 filed on Mar. 15, 2010, and 2010-245370 filed on Nov. 1, 2010, the entire contents of which are hereby incorporated herein by reference

### BACKGROUND OF THE INVENTION

1. Field of the Invention

The present invention generally relates to a fixing device fixing an image onto a recording medium and an image forming apparatus using the fixing device, the image having been transferred onto the recording medium based on an electrostatic transfer method.

2. Description of the Related Art

In a general image forming apparatus, especially in an image forming apparatus requiring a high-speed print output, the electrophotographic method is widely used.

In an image forming apparatus using the electrophotographic method and including a fixing device having a function of preventing toner from being adhered to a surface of a heat roller by applying oil to the surface of the heat roller and wiping off the remaining toner on the surface of the heat roller, generally, the oil stored in an oil tank is supplied to an oil web such as felt using a pump or the like so that a predetermined amount of oil is supplied to the oil web to be further applied to the surface of the heat roller.

In the following, as a basic example, an image forming apparatus is described that uses a continuous web (paper) as a recording medium.

FIG. 1 schematically illustrates an image forming apparatus employing the electrophotographic method. As schematically illustrated in FIG. 1, the image forming apparatus includes a charge device 1, a photosensitive body 2, an exposure device 3 emitting laser light or the like, a development device 4, a feeding unit 7, a heat roller 11 fixing a toner image 5 onto a recording medium (continuous web (paper)) 6, an oil web 10 applying oil to and cleaning the surface of the heat roller 11, a backup roller 12 pressing the continuous web (paper) 6 toward the heat roller 11 during fixing, an oil supply mechanism 14 supplying oil to the oil web 10 using a pump, a winder drive mechanism 15 sequentially providing a new part of the oil web 10, and a puller roller 13 discharging the continuous web 6. FIG. 1 further illustrates the positional relationships among the above elements.

In this image forming apparatus, a latent image is formed on a surface of the photosensitive body 2 by the exposure device 3, the surface of the photosensitive body 2 being charged by the charge device 1. Then, the latent image is developed by the development device 4, so that the corresponding toner, image is formed.

On the other hand, the continuous web 6 is fed by the feeding unit (web feeding unit) 7, so that the toner image on the photosensitive body 2 is transferred onto the continuous web 6. The continuous web 6 is further fed in between the heat roller 11 and the backup roller 12 to be heated and pressed, so that the toner image 5 is fixed onto the continuous web (print media web) 6. Then, the continuous web 6 is discharged by the puller roller 13.

In this case, it is usual that an ultra-high-speed image forming apparatus having a printing speed equal to or greater than 200 PPM includes the heat roller 11 having an outer diameter equal to or greater than 70 mm for ensuring sufficient fixing capability.

Further, the temperature of the surface layer of the heat roller 11 is controlled to be heated up to approximately 200° C. Therefore, the surface layer of the heat roller 11 is required to be made of a material having high thermal resistance, friction resistance, and oil resistance. The material includes fluorine based resin such as PFA (tetrafluoroethylene-perfluoro alkyl vinyl ether copolymer), PTFE (polytetrafluoroethylene), and FEP (tetrafluoroethylene-hexafluoro propylene copolymer). Among the fluorine based resins, the PFA may be the most appropriate material.

Further, conventionally, in an image forming apparatus mostly printing text patterns, the fixing capability has been ensured by using a hard heat roller having a core of the heat roller 11 on which a surface coating layer made of PFA having a thickness in a range from 10 μm to 50 μm is coated by burning.

However, due to a recent strong demand for reproducing a high-quality image in the image forming apparatus, to prevent the image quality from being degraded due to the fixing section (fixing device), a soft roller or a semi soft roller has been generally used, the soft roller including a rubber layer having high thermal conductivity between the core of the heat roller 11 and the surface coating layer made of PFA as described in Japanese Patent Application No. 2005-77671 (“Patent Document 1”), the semi soft layer including the core of the heat roller 11 and the PFA tube having a thickness approximately in a range from 100 μm to 300 μm as the surface coating layer.

Further, FIG. 2 is a cross-sectional view of an oil application device described in Japanese Patent Application Publication No. 63-101882 (“Patent Document 2”). As illustrated in FIG. 2, the oil application device includes an endless oil web 10 for cleaning the heat roller 11. The endless oil web 10 is folded in a zig-zag manner so that the size of the oil application device as a whole may be reduced and the long oil web may be contained in the oil application device in a good manner.

In this oil application device, it may be possible to always supply a certain amount of oil to the heat roller 11. However, the oil web 10 is always in contact with the heat roller 11. Therefore, oil is continuously applied to the heat roller 11. Due to this feature, it may be difficult to adaptively control the amount of oil to be applied to the surface of the heat roller 11.

Further, Japanese Patent Application Publication 9-44021 (“Patent Document 3”) describes a blade to remove oil applied to the surface of the heat roller 11. By using the blade, oil may be removed, thereby enabling controlling the amount of oil applied to the surface of the heat roller 11.

Further, Japanese Patent Application Publication 7-271230 (“Patent Document 4”) describes the contact angle of the blade and the pressing force applied from the blade to the heat roller.

FIGS. 3 through 5 illustrate how oil 18 is being applied to the heat roller 11 and the continuous web 6 (typically an adhesion pressure bonding continuous web (paper) 6p). Specifically, FIG. 3 illustrates a state where the feed of the continuous web 6 is being stopped; FIG. 4 illustrates a state where the feed of the continuous web 6 is just started; and FIG. 5 illustrates a state where the printing is being performed.

As illustrated in FIG. 3, while the feed of the continuous web 6 is being stopped, the backup roller 12 is pulled back from the heat roller so that the continuous web 6 is separated from the heat roller 11. Even in this state, the heat roller 11 continues to rotate and oil having been supplied by the oil web 10 is applied to the entire circumference (surface) of the heat roller 11 and is in a waiting mode.

On the other hand, as illustrated in FIG. 5, during printing, the oil 18 having been applied to the heat roller 11 from the oil web 10 is transferred to the continuous web 6 via the heat roller 11 and consumed by the continuous web 6.

However, when the web (continuous web) feed is resumed after the web feed is being stopped, the rotation of the heat roller 11 is temporarily stopped at the timing when the backup roller 12 is swung (moved) and starts pressing the heat roller 11. Then, after the pressing is completed (in full), the heat roller 11 suddenly accelerates its rotational speed as quickly as possible up to a predetermined rotational speed. Because of the behavior of the heat roller 11, namely due to the stop of the rotation first and followed by the sudden acceleration of the rotational speed as quickly as possible, the friction applied to the heat roller 11 may be accordingly increased. Further, in this case, due to the pressing force applied from the backup roller 12 to the heat roller 11, a force is further applied from the heat roller 11 to the oil web 10. Due to this force, oil impregnated in the oil web 10 oozes out to the surface of the oil web 10. As a result, as illustrated in FIG. 4, more oil may be temporarily applied from the oil web 10 to the surface of the heat roller 11 when compared with a case where the web (continuous web) is being fed.

During the state where more oil is temporarily applied to the surface of the heat roller 11, if printing is performed on the continuous web 6 such as the adhesion pressure bonding continuous web 6p, right after the web feed is started, much of the oil 18 adhered to the heat roller 11 may be adhered to the surface of the adhesion pressure bonding continuous web 6p, thereby degrading the pressure bonding capability of the adhesion pressure bonding continuous web 6p.

Further, if an amount of oil to be supplied to the oil web 10 is reduced, it may be possible to supply an appropriate amount of oil to the adhesion pressure bonding continuous web 6p just after the web feed is started. However, as illustrated in FIG. 5, an insufficient amount of oil may be applied during printing. As a result, the mold releasability between the heat roller 11 and the toner image 5 may be degraded, which may cause the adhesion of the toner image 5 to the surface of the heat roller 11.

Further, the amount of oil having been supplied to the oil web 10 may not be promptly decreased while the web feed is being stopped. Namely, even if the oil supply to the oil web 10 is controlled (reduced), it may not be possible to control (reduce) the oil 18 having already been supplied to the oil web 10. Accordingly, it may not be possible to promptly reduce an amount of the oil 18 supplied to the surface of the heat roller 11.

Patent Document 3 merely describes the contact angle of the blade, but does not describe the pressing force of the blade.

Patent Document 4 does not describe any configuration corresponding to the use of the adhesion pressure bonding continuous web.

### SUMMARY OF THE INVENTION

The present invention is made in light of the above circumstances, and may provide a fixing device capable of resolving at least one of the problems in the related art and fixing toner without degrading the pressure bonding capability even when an adhesive pressure bonding continuous web is used, and an image forming apparatus using the fixing device.

To that end, according to an aspect of the present invention, there is provided a fixing device including a first roller facing an image forming surface of a recording medium on which an image is formed, a second roller that is provided in a manner such that the second roller can be in contact with and separated from the first roller and that faces a surface opposite to the image forming surface of the recording medium, a lubricant application unit applying lubricant to a surface of the first roller and wipes the surface of the first roller; a lubricant supply unit supplying lubricant to the lubricant application unit, a lubricant control blade disposed at a position and being in contact with and separated from the surface of the first roller, the position being disposed on a downstream side in a rotating direction of the first roller from a position where the lubricant application unit is in contact with the first roller and being disposed on an upstream side in the rotating direction of the first roller from a position where the second roller is in contact with and separated from the first roller, so that the recording medium on which the image is formed is sandwiched and fed between the first roller and the second roller so as to fix the image onto the recording medium. Further, a contact angle θ of the lubricant control blade relative to the first roller is in a range between 35 degrees and 43 degrees, and a linear pressure F applied from the lubricant control blade to the first roller is in a range from 0.35 N/cm to 0.5 N/cm.

### BRIEF DESCRIPTION OF THE DRAWINGS

Other objects, features, and advantages of the present invention will become more apparent from the following description when read in conjunction with the accompanying drawings, in which:

FIG. 1 is a drawing illustrating a schematic configuration of the entire image forming apparatus;

FIG. 2 is a cross-sectional view of a conventional oil application device;

FIG. 3 is a drawing illustrating a state where oil is adhered on the heat roller while a feed of an adhesion pressure bonding continuous web is being stopped;

FIG. 4 is a drawing illustrating a state where oil is adhered on the heat roller and the adhesion pressure bonding continuous web right after the feed of the adhesion pressure bonding continuous web is resumed;

FIG. 5 is a drawing illustrating a state where oil is adhered on the heat roller and the adhesion pressure bonding continuous web and a toner image is adhered while printing is being performed and the mold releasability between the heat roller and the toner image is degraded;

FIG. 6 is an exemplary functional block diagram of an image forming apparatus according to an embodiment of the present invention;

FIG. 7 is a drawing illustrating an exemplary functional configuration of main parts of the image forming apparatus according to an image forming apparatus according to an embodiment of the present invention;

FIG. 8 is a schematic drawing illustrating a structure of a fixing device having an oil control blade device according to an embodiment of the present invention;

FIG. 9 is a drawing illustrating operating states of the oil control blade device;

FIG. 10 is a characteristic diagram illustrating the change of an oil amount on the surface of the heat roller right after the feed of a pressure bonding continuous web is started in a case where the oil control blade is provided and in a case where the oil control blade is not provided;

FIG. 11 is a characteristic diagram illustrating a relationship between a contact angle θ of the oil control blade relative to the heat roller and the amount of oil on the surface of the heat roller;

FIG. 12 is a characteristic diagram illustrating a relationship between a linear pressure F of the oil control blade relative to the heat roller and the amount of oil on the surface of the heat roller;

FIG. 13 is a characteristic diagram illustrating a relationship between the rubber hardness of the blade and the amount of oil on the surface of the heat roller;

FIG. 14 is a time chart illustrating a relationship between a sheet feed and a blade position according to an embodiment of the present invention;

FIG. 15 is a time chart illustrating another relationship between the sheet feed and the blade position according to another embodiment of the present invention;

FIG. 16 is a drawing illustrating a third predetermined time;

FIG. 17 is a time chart illustrating a relationship between the sheet feed and the blade position according to still another embodiment of the present invention; and

FIG. 18 is a table illustrating experimental results to determine a second predetermined value X_{B}.

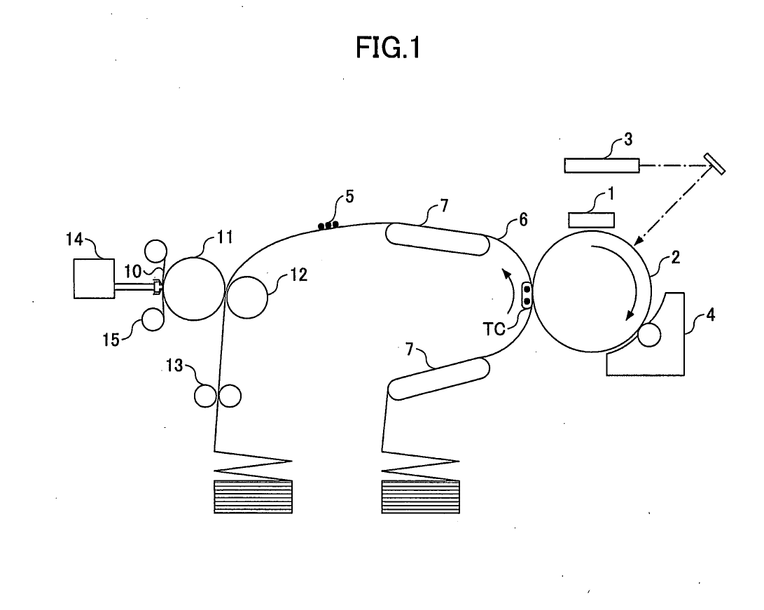

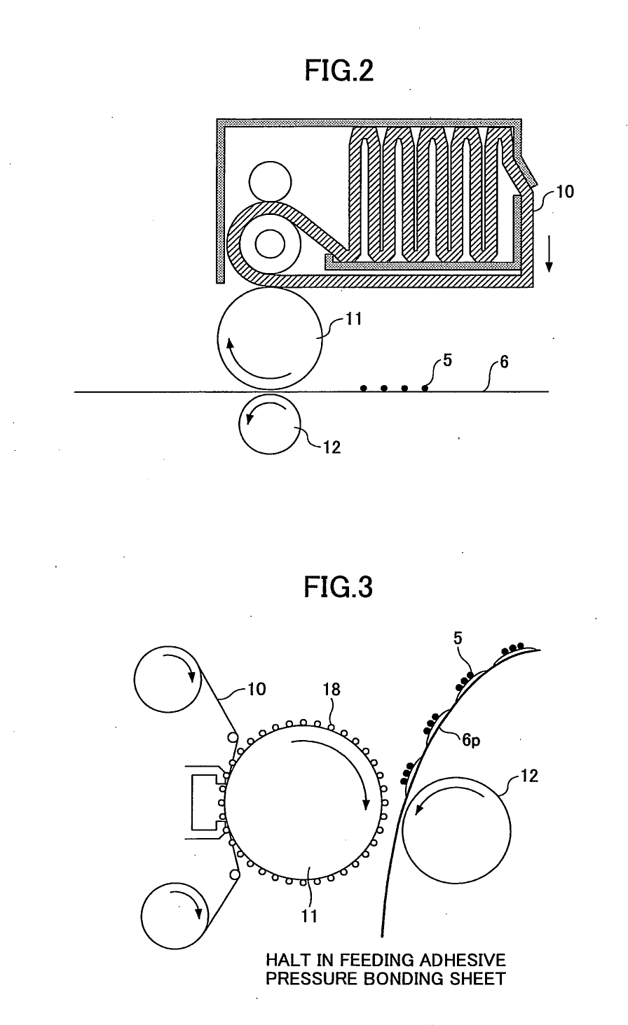

### DETAILED DESCRIPTION OF THE PREFERRED EMBODIMENTS

Before embodiments of the present invention are described, several terms used herein are described. An image forming apparatus refers to, for example, a printer, a facsimile machine, a copier, a plotter, and a multi function peripheral of those functions. Further, a recording medium refers to, for example, a medium made of paper, strings fiber, leather, metal, plastic, glass, wood, ceramic or the like. In the following, it is assumed that the recording medium is a continuous web. Further, image forming refers to an operation of adding (forming) an image of a character, a figure, a pattern and the like to the recording medium or simply ejecting fluid (ink) droplets onto the recording medium.

Among the accompanied drawings, the same reference numerals may be repeatedly used for the same elements having the same or equivalent function and repeated description thereof may be omitted.

### First Embodiment

### Exemplary Configuration

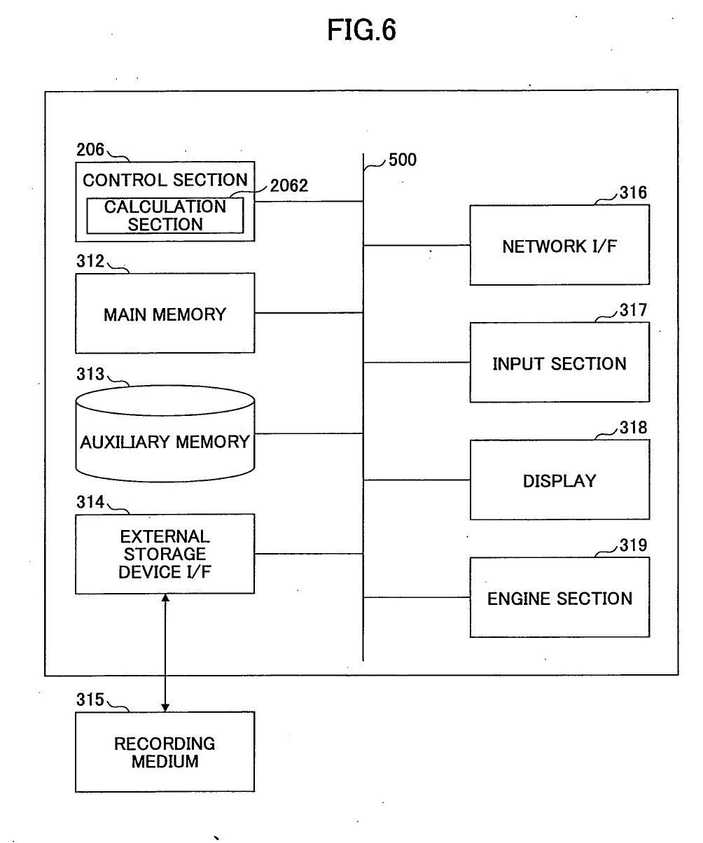

FIG. 6 is an exemplary functional block diagram of an image forming apparatus according to an embodiment of the present invention. As illustrated in FIG. 6, the image forming apparatus includes a control section 206, a main memory 312, an auxiliary memory 313, an external storage device I/F 314, a network I/F 316, an input section 317, a display 318, and an engine section 319. Those elements are connected to each other via a bus 500.

The control section 206 is a CPU (Central Processing Unit) that controls various devices and calculates and process data in the computer of the image forming apparatus. Further, the control section 206 is an arithmetic device executing a program stored in the main memory 312, receives data from the input device and the storage device, calculates and performs processing on the data, and outputs the data to the output device and the storage device.

The main memory 312 is a storage device such as a ROM (Read Only Memory), a RAM (Random Access Memory) and the like that stores or temporarily stores OS (Operating system) which is basic software, programs such as application programs, and data to be executed or used by the control section 206.

The auxiliary memory 313 is a storage device such as an HDD (Hard Disk Drive) storing data related to the application software and the like.

The external storage device I/F 314 is an interface between the image forming apparatus and a recording medium 315 (e.g., a flash memory) connected via a data transmission line such as a USB (Universal Serial Bus).

Further, a predetermined program is stored in the recording medium 315, so that the program stored in the recording medium 315 may be installed in the image forming apparatus via the external storage device I/F 314. By doing in this way, the installed predetermined program is executable in the image forming apparatus.

The network I/F 316 is an interface between the image forming apparatus and a peripheral device having a communication function connected to a network such a LAN (Local Area Network) and an WAN (Wide Area Network) including a data transmission line such as a wired line and/or a wireless line.

The input section 317 and the display 318 includes a keyboard (hard keys) and an LCD (Liquid Crystal Display) providing a touch panel function (including soft keys in GUI (Graphical User Interface)), and are used as a display device and/or an input device serving as a UI (User Interface) to use the functions of the image forming apparatus.

The engine section 319 drives the mechanical parts, motors and the like of the plotter, the scanner and the like to actually perform an image forming process.

### Configuration of Main Parts of Image Forming Apparatus

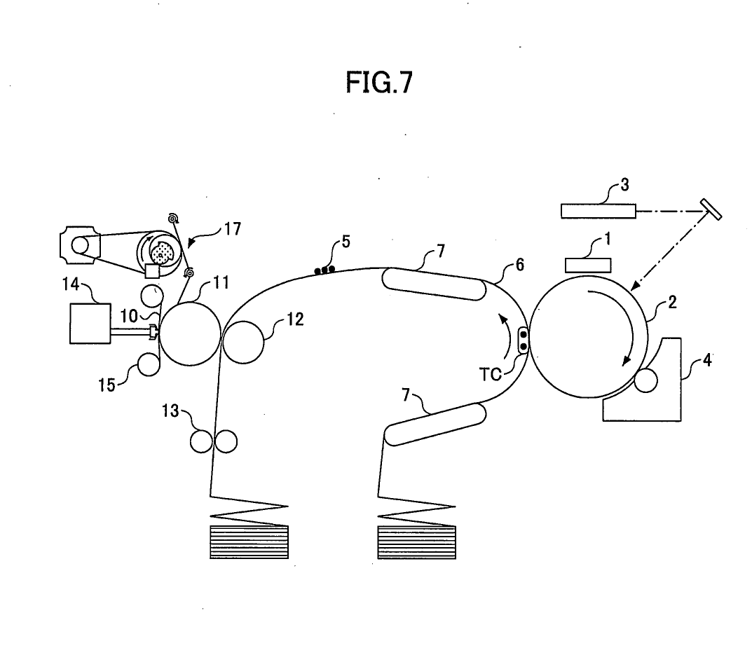

FIG. 7 illustrates main parts of an image forming apparatus according to a first embodiment of the present invention. As illustrated in FIG. 7, the image forming apparatus includes a charge device 1, a photosensitive body 2, a laser exposure device 3, a development device 4, a sheet feeding unit 7, a heat roller 11 fixing a toner image 5 on a recording medium (a long continuous web) 6, a backup roller 12 pressing the continuous web 6 toward the heat roller 11 during the fixing, an oil web 10 applying oil to and cleaning the heat roller 11, a lubricant supply mechanism 14 supplying lubricant to the oil web 10 using a pump, a winder drive mechanism 15 sequentially providing a new part of the oil web 10 to the heat roller 11, a puller roller 13 discharging the continuous web 6, and a blade driving unit 17 moving a blade section 31 so as to be in contact with and separate from the heat roller 11. The lubricant includes oil or the like. In the following, it is assumed that the lubricant is oil.

In the heat roller 11, there is a fixing heater. When power is supplied to the fixing heater, the temperature (fixing temperature) of the heat roller 11 is increased. The oil supply mechanism 14 supplies oil to the oil web 10 which is in contact with the heat roller 11. The oil is applied from the oil web 10 to the surface of the heat roller 11.

The backup roller 12 is capable of being in press contact with and separating from the heat roller 11 by a drive section (not shown) which is controlled by the control section 206 (see FIG. 6). Specifically, both ends of the axis of the backup roller 12 are supported by the respective swing arms (not shown). Due to the movement of the swing arms, the backup roller 12 is in press contact with the heat roller 11.

Further, the rotation of the heat roller 11 is controlled, and the backup roller 12 rotates following the rotation of the heat roller 11 due to the press contact with the heat roller 11. The control section 206 controls the press contact and the separation between the heat roller 11 and the backup roller 12.

Further, a latent image is formed on the surface of the photosensitive body 2 based on the image-forming exposure conducted by the laser exposure device 3, the surface of the photosensitive body 2 having been charged by the charge device 1. Then, the formed latent image is developed by the development device 4, so that the corresponding toner image may be formed on the photosensitive body 2. The continuous web 6 is fed by the sheet feeding unit 7, and the toner image on the photosensitive body 2 is transferred onto the continuous web 6 by a transfer unit TC which is transfer means (transfer unit). The continuous web 6 is further fed in between the heat roller 11 and the backup roller 12 being in press contact with each other, so that the toner image 5 is fixed onto the continuous web 6. Then, the continuous web 6 onto which the toner image 5 is fixed is further fed (discharged) by the puller roller 13.

Further, in an image forming apparatus according to an embodiment of the present invention, in order to ensure (enable) the high-speed fixing to achieve printing speed equal to or greater than 200 PPM, the heat roller 11 may be designed so that the outer diameter of the heat roller 11 is equal to or greater than 70 mm, preferably equal to or greater than 100 mm. By using the heat roller 11 having such a large outer diameter, namely by reducing the curvature of the outer circumference of the heat roller 11, it may become possible to provide a wider nip width (length), thereby enabling performing high-speed fixing.

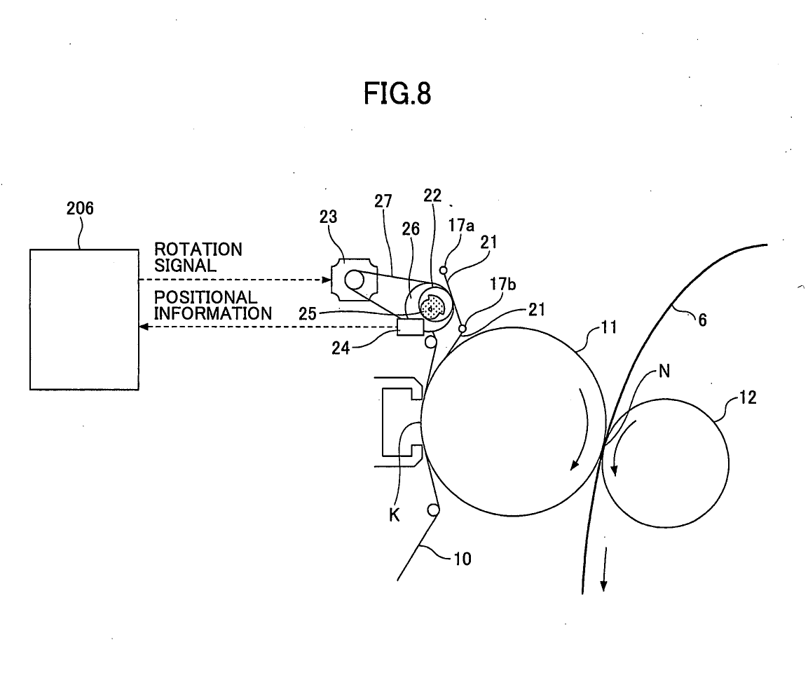

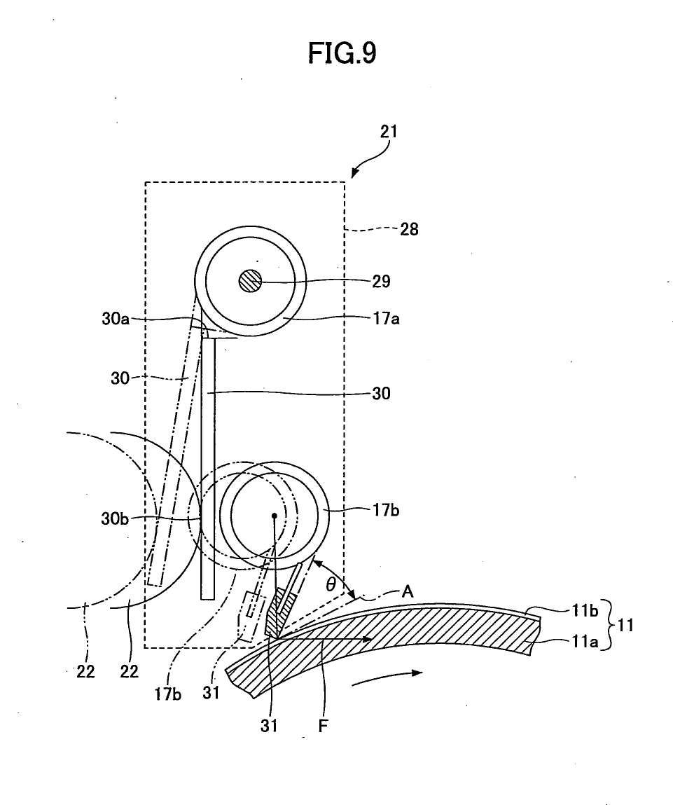

FIG. 8 schematically illustrates a structure of a fixing device having an oil control blade 21 according to an embodiment of the present invention. FIG. 9 schematically illustrates operations of the oil control blade 21.

As illustrated in FIG. 8, the oil control blade 21 according to an embodiment of the present invention is disposed on the downstream side of a position K in the rotating direction of the heat roller 11, the position K being a position where the oil web 10 is in contact with the heat roller. Further, the oil control blade 21 is disposed on the upstream side of a position N in the rotating direction of the heat roller 11, the position N being a position where the backup roller 12 is in press contact with and separated from the heat roller 11. In other words, the oil control blade 21 is displaced at a position between the position K and the position N along the rotating direction of the heat roller 11 (or in the rotating direction of the heat roller 11).

Further, as illustrated in FIG. 8, to control the operations of the oil control blade 21, there are provided a stepping motor 23, a pulley 26, a timing belt 27, an eccentric cam 22, an encoder 25, a positional sensor 24, and the control section 206 (see FIG. 6) and the like. FIG. 8 further illustrates the positional relationships among the above elements. The stepping motor 23 is a source of the rotation driving force to drive the oil control blade 21. The timing belt 27 transmits the rotation driving force from the stepping motor 23 to the pulley 26. The eccentric cam 22 is disposed on the same axis as that of the pulley 26. The oil control blade 21 is movably provided. The encoder 25 determines the position (state) of the eccentric cam 22. The positional sensor 24 obtains data of the rotation of the encoder (reflection plate) 25. The control section 206 determines the number of rotational steps of the stepping motor 23 based on a reference position detected by the positional sensor 24, and outputs a rotation signal (detection signal) based on the determination to the stepping motor 23.

Further, as illustrated in FIG. 9, the oil control blade 21 includes a unit main body 28, a supporting axis 29, a first twisted spring 17a, a blade support body 30 including a base end section 30a and a head section 30b, a second twisted spring 17b, and a blade section 31. The supporting axis 29 rotatably supports the unit main body 28 based on a base part (not shown). The first twisted spring 17a is disposed in a concentric manner relative to the supporting axis 29 and has one end connected to the supporting axis 29. The base end section 30a of the blade support body 30 is fastened to the distal end (free end) of the first twisted spring 17a. The head section 30b of the blade support body 30 is in contact with the cam surface of the eccentric cam 22. The base end section of the second twisted spring 17b is fastened to the distal end (free end) of the first twisted spring 17a. The distal end (free end) of the second twisted spring 17b is fastened to the base end section of the blade section 31. The blade section 31 has the distal end extending toward the heat roller 11 side.

The first twisted spring 17a has a spring force (restoring force) so as to rotate the second twisted spring 17b side of the blade support body 30 towards the eccentric cam 22 about the supporting axis 29. Due to the spring force, as described above, the blade support body 30 is in contact with the cam surface of the eccentric cam 22. Further, the blade support body 30 includes side surface sections on the both ends in the direction orthogonal to the figure sheet's surface in FIG. 9. The side surface sections support a shaft (not shown) which serves as a supporting axis of the second twisted spring 17b. The shaft has several (four in this embodiment) screw holes in its axis direction and is fixed on the base end side of the blade section 31.

By the rotation of the eccentric cam 22, the blade support body 30 is pressed, so that the blade support body 30 moves toward the heat roller 11 side. Accordingly, the second twisted spring 17b and the blade section 31 disposed on the end side (head section 30b side) are moved toward the heat roller 11 side. As a result, the head section of the blade section 31 is in press contact with the circumferential surface of the heat roller 11.

Further, the second twisted spring 17b is provided so as to prevent damage to the surface of the heat roller 11 due to an excessive force caused by some reason applied to the surface of the heat roller 11 while the blade support body 30 is being moved due to the rotation of the eccentric cam 22 so that the blade section 31 is in press contact with the circumferential surface of the heat roller 11.

The blade section 31 may be formed by baking and fixing fluorine-containing rubber having a predetermined elasticity to one end of a plate member having rigidity and a supporting function (capability). Further, the width of the blade section 31 is slightly longer than the width of a usable continuous web 6 and is similar to the width of the surface coating layer 11b (see FIG. 9) of the heat roller 11.

As illustrated in FIG. 8, the stepping motor 23 rotates based on the rotation signal from the control section 206, and the rotation driving force is transmitted to the pulley 26 via the timing belt 27. The eccentric cam 22 is provided on the pulley 26. When the cam surface of the eccentric cam 22 is disposed at the most receded (farthest) position (i.e., the position of the eccentric cam 22 illustrated in a dashed-dotted line in FIG. 9) relative to the oil control blade 21, the oil control blade 21 is disposed at a position where the oil control blade 21 as a whole is receded from the heat roller 11 around the supporting axis 29. As a result, the blade section 31 is stopped at a position where the blade section 31 is receded from the heat roller 11 as illustrated by a dashed-dotted line in FIG. 9.

By the rotation of the eccentric cam 22, when the cam surface of the eccentric cam 22 is disposed at the advanced (closest) position (i.e., the position of the eccentric cam 22 illustrated in a solid line in FIG. 9) relative to the oil control blade 21, the oil control blade 21 as a whole rotates in counterclockwise direction around the supporting axis 29 from the receded position and stops at a position where the blade section 31 is in press contact with the heat roller 11. The contact pressure applied from the blade section 31 to the heat roller 11 is maintained at a constant level due to the spring constant of the second twisted spring 17b.

As described with reference to FIG. 9, due to the press contact between the head section of the blade section 31 and the circumferential surface of the heat roller 11, extra oil adhered to the surface of the circumferential surface of the heat roller 11 may be removed so that an amount of oil on the circumferential surface of the heat roller 11 may be better controlled.

During the feeding of the continuous web 6 (i.e., during printing), the oil 18 on the heat roller 11 is continuously consumed by the continuous web 6. Further, while the feeding of the web is being stopped, as illustrated in FIG. 3, the oil 18 is not consumed by the continuous web 6. However, in this case, the feeding may be stopped for a long time period while the power is being supplied. Therefore, to prevent the oil web 10 from being dried, a small amount of oil 18 is applied to the heat roller 18. In the oil supply mechanism 14, an oil supply amount per operation of the pump is constant. Therefore, to apply only a small amount of oil 18 to the heat roller 18, the frequency (times per predetermined time cycle) of the oil supply is reduced when compared with a case of printing.

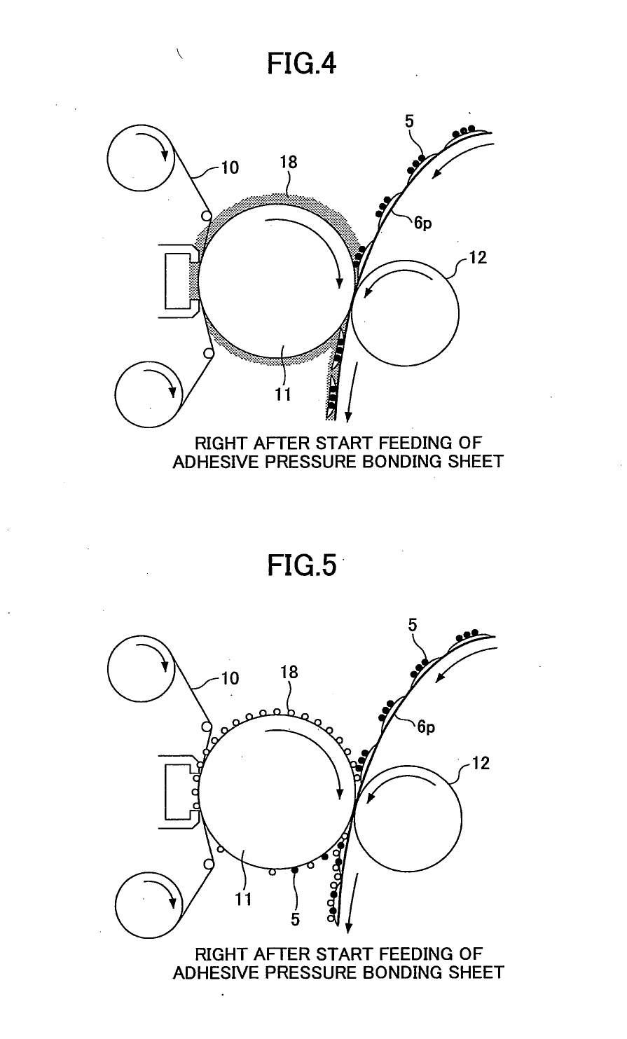

Further, when the web (continuous web) feed is resumed after the web feed is being stopped, as illustrated in FIG. 4, the rotation of the heat roller 11 is temporarily stopped at the timing when the backup roller 12 is swung and start pressing the heat roller 11. Then, after the pressing is completed (or in full), the heat roller 11 promptly accelerates its rotational speed as quickly as possible up to a predetermined rotational speed. In this case, due to the pressing force applied from the backup roller 12 to the heat roller 11, oil impregnated in the oil web 10 may ooze out to the surface of the oil web 10. As a result, as illustrated in FIG. 4, more oil May be temporarily applied from the oil web 10 to the surface of the heat roller 11 when compared with a case where the web (continuous web) is being fed.

Before the web feed is started, the control section 206 performs control to rotate the stepping motor 23 so that the oil control blade 21 (blade section 31) is in contact with the heat roller 11 so as to (temporarily) remove excessive oil adhered to the surface of the heat roller 11 or return the (temporarily) removed oil 18 back to the surface of the heat roller 11. Due to the removal and the return of the oil 18, when the web feed is started to print an image onto the adhesive pressure bonding continuous web or the like, it may become possible to better control the application of excessive oil 18 to the surface of the adhesive pressure bonding continuous web or the like, thereby enabling preventing the degradation of the pressure bonding capability of the adhesive pressure bonding continuous web.

Moreover, the inventors of the present invention conducted various experiments and have discovered that the oil removal capability varies depending on conditions such as a contact angle θ (see FIG. 9) of the oil control blade 21 relative to the heat roller 11, a linear pressure F (see also FIG. 9) to the heat roller 11, and a relationship between a surface hardness of the heat roller 11 and a rubber hardness Hs of the oil control blade 21; and that there may be a case where sufficient effect may not be obtained depending on the conditions. Herein, the contact angle θ refers to an acute angle between the tangent line A of the circle of the heat roller and the blade section 31 when it is viewed on the circle plane of the heat roller 11.

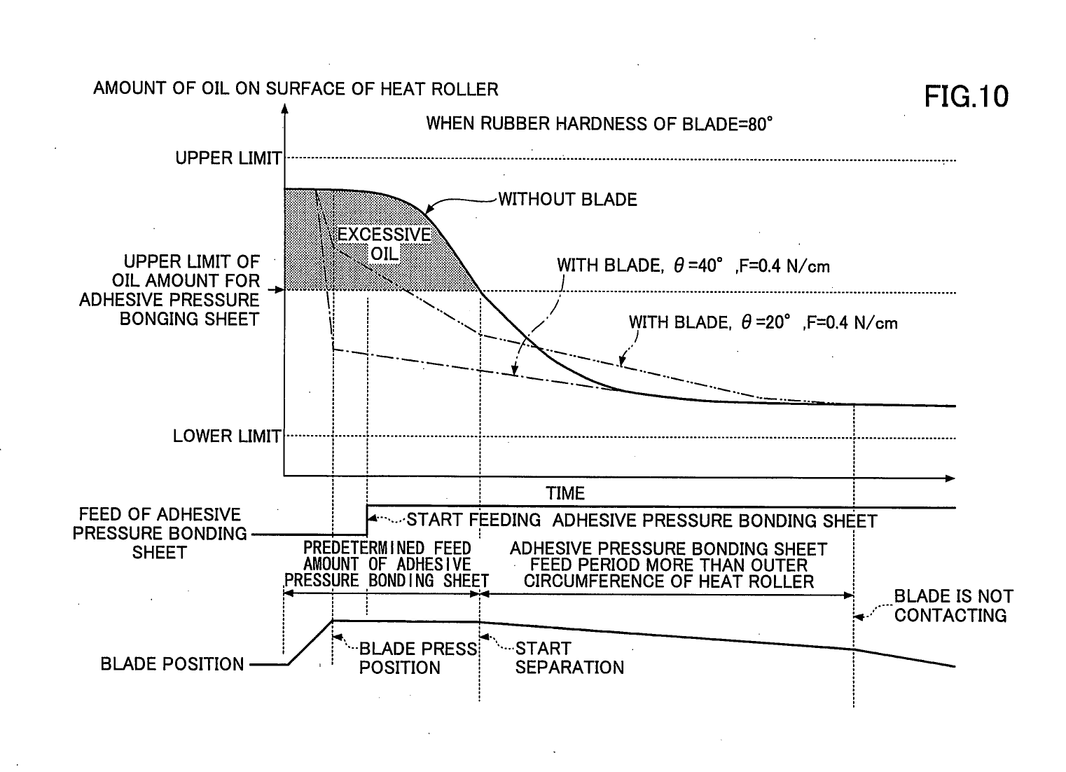

FIG. 10 is a characteristic diagram illustrating the change of an oil amount on the surface of the heat roller 11 as soon as the web feeding is started with the following three cases. The first case is drawn in a solid line where no oil control blade 21 is used; the second case is drawn in a dashed-dotted line where the oil control blade 21 is used with the contact angle θ between the oil control blade 21 and the heat roller 11 set to be 40 degrees and the linear pressure F applied from the oil control blade 21 to the heat roller 11 set to be 0.4 N/cm; and the third case is drawn in a dashed-two dotted line where the oil control blade 21 is used with the contact angle θ between the oil control blade 21 and the heat roller 11 set to be 20 degrees and the linear pressure F applied from the oil control blade 21 to the heat roller 11 set to be 0.4 N/cm.

In FIG. 10, the vertical axis denotes an mount of oil (oil amount) on the surface of the heat roller 11, and an upper limit value (level) of the amount of oil applied on the heat roller 11 so as to (appropriately and successfully) achieve the pressure bonding of the adhered pressure bonding continuous web is additionally described. On the other hand, the lateral axis denotes elapsed time, and an operation timing of starting the feed of the continuous web 6 and operation timings of the oil control blade 21 are additionally described.

In the experiments, as the heat roller 11, a hard heat roller that has a core 11a and the surface coating layer 11b made of PFA and having a thickness approximately in a range from 10 μm to 50 μm and that is formed by baking and fixing the surface coating layer 11b to the core 11a is used. Further, the blade section 31 of the oil control blade 21 is made of fluorine-containing rubber having high thermal resistance and oil resistance, and the rubber hardness Hs of the oil control blade 21 is 80°.

As may be apparent from FIG. 10, when no oil control blade 21 is used (in solid line), an excessive oil apply amount greater than the upper limit value of the oil amount on the heat roller 11 remains from the start of the web feed until the web feed amount reaches a predetermined feed amount. During that time period, an excessive amount of oil may be applied to an adhesion pressure bonding continuous web 6p.

On the other hand, in the cases where the oil control blade 21 is used (in dashed-dotted line and dashed-two dotted line), the oil amount applied on the heat roller 11 is better controlled (reduced) by the oil control blade 21 from the start of the web feed, and as a result the pressure bonding capability may be improved. However, the oil amount on the heat roller 11 differs depending on the contact angle θ.

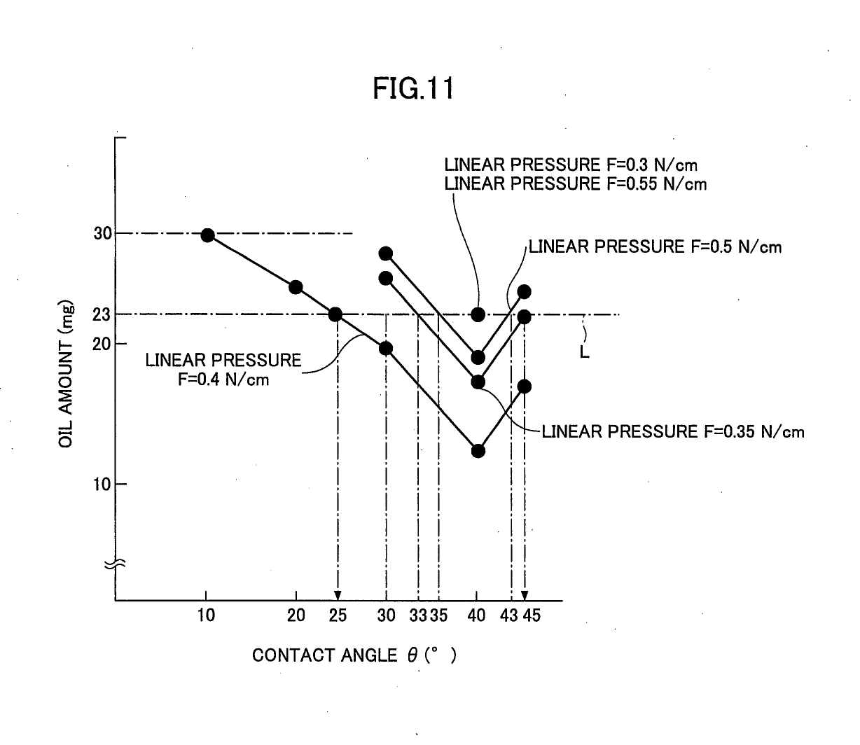

FIG. 11 is a characteristic diagram illustrating a relationship between the contact angle θ between the oil control blade 21 and the heat roller 11 and the amount of oil on the surface of the heat roller 11. During the experiment, the oil control blade 21 made of fluorine-containing rubber having the rubber hardness Hs 80° is used. Further, the linear pressure F applied from the oil control blade 21 to the heat roller 11 is set to be 0.3 N/cm, 0.35 N/cm, 0.4 N/cm, 0.5 N/, and 0.55 N/cm, and the contact angle θ is changed 10 degrees, 20 degrees, 25 degrees, 30 degrees, 40 degrees, and 45 degrees.

Further, in the following experiments, an amount of oil transferred (oil transfer amount) onto the continuous web 6 is measured. Specifically, an oil amount corresponding to one revolution of the heat roller 11 is transferred onto an OHP sheet when feed is restarted after the feed is stopped which is the case where the maximum oil amount may be applied. Then, the transferred oil is measured using an accurate weighing machine having a measurement resolution as high as 0.001 g, and the measured value is converted into a value corresponding to a weight value on one sheet having “A4” size.

Further, in FIG. 11, the line L disposed at a position corresponding to the oil amount 23 g on the surface of the heat roller 11 denotes the upper limit value of the oil amount on the heat roller 11 where the pressure bonding capability of the adhesion pressure bonding continuous web 6p can be maintained. Therefore, if the oil amount on the heat roller 11 exceeds (higher than) the line L, the pressure bonding capability of the adhesion pressure bonding continuous web 6p may be insufficient, and as a result, the adhesive pressure bonding capability may not be fully performed (provided). Therefore, by using the line L as a reference, the ranges of the contact angle θ and the linear pressure F are appropriately specified as described below.

In a case where the linear pressure F is 0.4 N/cm, when the contact angle θ between the oil control blade 21 and the heat roller 11 is 10 degree, the oil amount on the surface of the heat roller 11 is 30 mg. As a result, the pressure bonding capability of the adhesion pressure bonding continuous web 6p may be insufficient and the adhesive pressure bonding capability may not be fully performed.

On the other hand, when the contact angle θ between the oil control blade 21 and the heat roller 11 is equal to or greater than 25 degrees, the oil amount on the surface of the heat roller 11 may be controlled to be equal to or less than 23 mg. As a result, the pressure bonding capability of the adhesion pressure bonding continuous web 6p may be maintained at a predetermined strength. Especially, when the contact angle θ is in a range from 30 degrees to 45 degrees, the oil amount on the surface of the heat roller 11 may be more appropriately maintained. However, if the contact angle θ is greater than 45 degrees, the angle of the oil control blade 21 relative to the circumferential surface of the heat roller 11 may become too large, which may cause the linear pressure F to be unstable. As a result, oil removal capability may not be fully performed.

Therefore, when the contact angle θ between the oil control blade 21 and the heat roller 11 is set to be in a range between 25 degrees and 45 degrees, preferably in a range in a range between 30 degrees and 45 degrees, more preferably 40 degrees, it may become possible to ensure the pressure bonding capability of the adhesion pressure bonding continuous web 6p.

In a case where the linear pressure F is 0.35 N/cm, to control the oil amount on the surface of the heat roller 11 to be equal to or less than 23 mg, the contact angle θ may be set in a range between 33 degrees and 45 degrees.

In a case where the linear pressure F is 0.5 N/cm, to control the oil amount on the surface of the heat roller 11 to be equal to or less than 23 mg, the contact angle θ may be set in a range between 35 degrees and 43 degrees.

In a case where the linear pressure F is 0.3 N/cm or 0.55 N/cm, when the contact angle θ is set to be 40 degrees, the oil amount on the surface of the heat roller 11 is controlled to be equal to or less than 23 mg.

According to results of FIG. 11, when the linear pressure F is set in a range between 0.35 N/cm and 0.5 N/cm and the contact angle θ is set in a range between 35 degrees and 43 degrees, it may become possible to control the oil amount on the surface of the heat roller 11 to be equal to or less than 23 mg. Therefore, when the linear pressure F is in a range between 0.35 N/cm and 0.5 N/cm and the contact angle θ is in a range between 35 degrees and 43 degrees, the oil amount applied to the surface of the heat roller 11 may be appropriately controlled, and as a result, when the adhesion pressure bonding continuous web 6p or the like is used, toner may be appropriately fixed without degrading the pressure bonding capability.

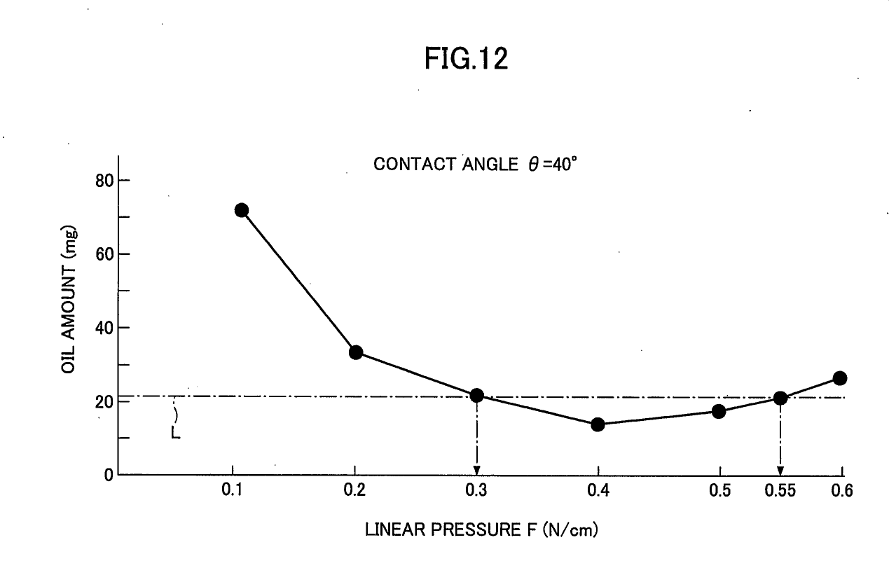

FIG. 12 is a characteristic diagram illustrating a relationship between a linear pressure F applied from the oil control blade 21 to the heat roller 11 and the amount of oil on the surface of the heat roller 11. In the experiment, the oil control blade 21 made of fluorine-containing rubber having the rubber hardness Hs 85° is used. Further, the contact angle θ is set to be a constant value of 40 degrees, and the linear pressure F applied from the oil control blade 21 to the heat roller 11 is set to be (changed) 0.1 N/cm, 0.2 N/cm, 0.3 N/cm, 0.4 N/cm, 0.5 N/, 0.55 N/cm, and 0.6 N/cm.

In this case, the linear pressure F applied from the oil control blade 21 to the heat roller 11 is appropriately adjusted by changing the spring constant of the second twisted spring 17b described in FIG. 9.

As may be apparent from FIG. 12, even in a case where the contact angle θ between the oil control blade 21 and the heat roller 11 is 40 degrees, if the linear pressure F applied from the oil control blade 21 to the heat roller 11 is 0.1 N/cm, the oil amount on the surface of the heat roller 11 may be excessive. Therefore, the pressure bonding capability of the adhesion pressure bonding continuous web 6p may be insufficient and the adhesive pressure bonding capability may not be fully performed.

On the other hand, when the linear pressure F applied from the oil control blade 21 to the heat roller 11 is set in a range between 0.3 N/cm and 0.55 N/cm, preferably in a range between 0.4 N/cm and 0.5 N/cm, and more preferably 0.4 N/cm, it may become possible to control the oil amount on the surface of the heat roller 11 to be equal to or less than 23 mg, thereby ensuring the pressure bonding capability of the adhesion pressure bonding continuous web 6p. Further, according other experiences, this tendency is also applied when the contact angle θ between the oil control blade 21 and the heat roller 11 is changed in a range between 25 degrees and 45 degrees.

It is proved in another experiment that, when the contact angle θ is 25 degrees or 45 degrees, it is preferable to set the linear pressure F to be 0.4 N/cm.

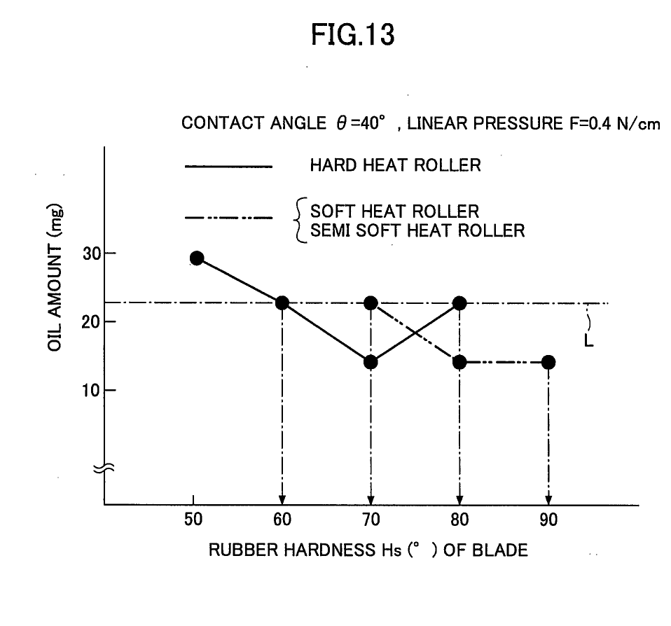

FIG. 13 is a characteristic diagram illustrating a relationship between the rubber hardness of the oil control blade 21 and the amount of oil on the surface of the heat roller 11. In the experiment, the contact angle θ is set to be a constant value of 40 degrees and the linear pressure F applied from the oil control blade 21 to the heat roller 11 is set to be a constant value of 0.4 N/cm. Then, the rubber hardness Hs of the fluorine-containing rubber of the oil control blade 21 is changed.

In the graph of FIG. 13, the solid line denotes the oil amount when a hard heat roller that has a core 11a and the surface coating layer 11b made of PFA and having a thickness in a range from 10 μm to 50 μm and that is formed by baking and fixing the surface coating layer 11b to the core 11a is used as the heat roller 11. On the other hand, the dashed-two dotted line denotes the oil amount when a soft heat roller that has the core 11a, the surface coating layer 11b made of PFA and having a thickness of 100 μm, and a rubber layer that has improved thermal conductivity by incorporating metal silicon, that has a thickness of 400 μm, and that is formed, between the core 11a and the surface coating layer 11b and when a semi soft heat roller that has the core 11a and the surface coating layer 11b made of PFA and having a thickness in a range between 100 μm and 300 μm. As illustrated in the dashed-two dotted line, the characteristics of the soft heat roller is similar to that of the semi soft heat roller.

As may be apparent from FIG. 13, the relationship between the rubber hardness of the oil control blade 21 and the amount of oil on the surface of the heat roller 11 depends on the rubber hardness of the oil control blade 21 (i.e., the configuration of the heat roller 11).

In the case of the hard heat roller (solid line), when the rubber hardness of the oil control blade 21 is in a range between 60° and 80°, or preferably 70°, higher oil removal capability may be obtained. Therefore, in the case of the hard heat roller, it may be required to control so that the rubber hardness of the oil control blade 21 is in a range between 60° and 80°.

On the other hand, in the case of the soft heat roller or the semi soft heat roller (dashed-two dotted line), when the rubber hardness of the oil control blade 21 is in a range between 70° and 90°, or preferably in a range between 80° and 90°, higher oil removal capability may be obtained.

In the above example of the soft heat controller, a case is described where the thickness of the rubber layer having improved thermal conductivity is 400 μm. However, it is proved in another experiment that when the thickness of the rubber layer having improved thermal conductivity is 200 μm, substantially the same result as that when the thickness is 400 μm is obtained.

It is also proved in another experiment that the relationship between the rubber hardness of the oil control blade 21 and the amount of oil on the surface of the heat roller 11 is substantially maintained even when the contact angle θ between the oil control blade 21 and the heat roller 11 is (changed) in a range between 25 degrees and 45 degrees and even when the linear pressure F applied from the oil control blade 21 to the heat roller 11 is (changed) in a range between 0.3 N/cm and 0.55 N/cm.

Further, it is known that the rubber hardness Hs varies in a range of +/−5°. Further, due to the limit in manufacturing, an upper value of the rubber hardness Hs is in a range between 90° and 95°.

Further, in an image forming apparatus according to an embodiment of the present invention, to ensure (enable) the high-speed fixing to achieve printing speed equal to or greater than 200 PPM, the heat roller 11 is designed so that the outer diameter of the heat roller 11 is equal to or greater than 70 mm. Further, to achieve a higher quality image, the thicker the rubber layer is and the thinner the PFA layer, the higher the quality of the image becomes. However, as the surface coating layer, from the viewpoint of the friction resistance, it may be required that the thickness of the PFA layer is equal to or greater than 70 μm. Further, from the viewpoint of the thermal response, it is appropriate that the thickness of the rubber layer is in a range between 20 μm and 500 μm.

As described above, by determining appropriate values of the contact angle θ between the oil control blade 21 and the heat roller 11, and the linear pressure F applied from the oil control blade 21 to the heat roller 11, the rubber hardness of the oil control blade 21 in accordance with the hardness of the heat roller 11, it may become possible to remove (reduce) the excessive amount of oil applied to the surface of the heat roller when the web feed is resumed and appropriately control the oil amount on the surface of the heat roller 11. By doing in this way, it may become possible to provide a fixing device that does not degrade the pressure bonding capability of the adhesion pressure bonding continuous web 6p by maintaining the pressure bonding capability similar to that in printing.

Especially, by controlling so that the contact angle θ is in a range between 35 degrees and 43 degrees and the linear pressure F of the oil control blade 21 (for removing lubricant) is in a range between 0.35 N/cm and 0.5 N/cm, it may become possible to appropriately control the oil amount on the surface of the heat roller 11, and even when the adhesion pressure bonding continuous web 6p or the like is used, toner may be appropriately fixed without degrading the pressure bonding capability.

In the above embodiment, a case is described where PFA (tetrafluoroethylene-perfluoro alkyl vinyl ether copolymer) is used as the surface coating layer. However, for example, fluorine based resin such as PTFE (polytetrafluoroethylene), or FEP (tetrafluoroethylene-hexafluoro propylene copolymer) may alternatively be used as the surface coating layer.

In the above embodiment, a case is described where the adhesion pressure bonding continuous web 6p is used. However, needless to say, the present invention may also be applied to a case where a normal sheet is used.

In the above embodiment, a case is described where metal silicon is used to form the rubber layer having improved thermal conductivity. However, instead of using metal silicon, a predetermined amount of another transcalent material such as alumina fine particles, silica or the like may be added.

### Second Embodiment

Next, a fixing device and an image forming apparatus according to a second embodiment of the present invention is described. In the fixing device according to the second embodiment of the present invention, the oil amount on the heat roller 11 may be appropriately controlled by appropriately controlling the oil control blade 21.

First, a problem is described in a case where the oil control blade 21 is not controlled.

For example, in the configuration of the fixing device described in Patent Document 2, by the oil supply mechanism 14, a predetermined amount of oil necessary when the continuous web is being fed and when the sheet feed is being stopped is supplied to the oil web 10. The amount of oil impregnated in the oil web 10 may not be promptly changed even when, for example, the amount of oil supplied to the oil web is reduced. Further, the oil web 10 is always in contact with the heat roller 11 and continues to apply oil to the heat roller 11. Because of the features, it may be difficult to control the oil supply mechanism 14 to promptly change the amount of oil applied to the surface of the heat roller 11.

Normally, the oil applied to the surface of the heat roller 11 by the oil web 10 is consumed by the continuous web 6 while the continuous web 6 is being fed. However, while the sheet feed is being stopped, the continuous web 6 is separated from the heat roller 11. Therefore, no oil is consumed by the continuous web 6. As a result, while the sheet feed is being stopped, a larger amount of oil may be applied to the heat roller 11 than the amount when the continuous web is being fed. In this state, if the printing is started using the adhesion pressure bonding continuous web 6p or the like as the continuous web 6, right after the printing is started, the oil adhered (applied) to the heat roller 11 may be excessively applied to the surface of the adhesion pressure bonding continuous web 6p. As a result, in the part where excessive oil is applied to, the pressure bonding capability when the adhesive pressure bonding continuous web is pressed may be degraded.

The fixing device and the image forming apparatus according to the second embodiment of the present invention may solve the above problem by appropriately adjusting the amount of oil applied to the surface of the heat roller 11.

According to the second embodiment of the present invention, the control section 206 (see FIG. 12) control the stepping motor 23 to move step by step in the normal circulation direction (i.e., in the clockwise direction of the eccentric cam 22 in FIG. 8) and initializes (resets) a counter data value to be “0” at a reference (home position: rotation angle “0”) when the detection signal of the positional sensor 24 is switched from a H (High) level (where no detection of protrusion indicating the encoder (reflection plate) 25) to a L (Low) level (where the protrusion is detected). The control section 206 increments the counter data value by one per one step of the movement. The counter data value represents the rotation angle of the eccentric cam 22 (i.e., the rotation angle of the second twisted spring 17b). Therefore, while the blade section 31 of the oil control blade 21 is in contact with the heat roller 11 (i.e., while the continuous web is being fed), the pressing force applied from the header part of the blade section 31 to the heat roller 11 corresponds to the counter data value. On the other hand, while the blade section 31 of the oil control blade 21 is separated from the heat roller 11, the distance between the header part of the blade section 31 and the heat roller 11 correspond to the counter data value. The control section 206 drives the blade section 31 via the eccentric cam 22 by driving the stepping motor 23 step by step, and control (the change of) the pressing force applied from the blade section 31 to the heat roller 11 and the distance between the blade section 31 and the heat roller 11 based on the counter data value.

Further, in this second embodiment, oil is always applied to the surface of the heat roller 11 by the oil web 10. Further, a necessary amount of oil differs between in printing and in non-printing. Therefore, the control section 206 always performs apply control of oil. To that end, the control section 206 controls (changes) the interval of supplying oil to the oil web 10 by the oil supply mechanism 14. The oil supply amount per one operation of the oil supply mechanism 14 is a constant amount, and the oil supply is being appropriately performed during printing. On the other hand, during non-printing (i.e., while printing is not being performed), to prevent oil shortage on the heat roller 11 due to a long waiting state of the heat roller 11, it is set that the oil is supplied to the heat roller 11 at a time interval (e.g., once in about three minutes) which is longer than that is set for printing.

Further, while the continuous web 6 is sandwiched and fed by the heat roller 11 and the backup roller 12, the oil on the surface of the heat roller 11 is gradually consumed by being transferred onto the continuous web 6. On the other hand, while the blade section 31 is not in press contact with the surface of the heat roller 11 and no continuous web 6 is sandwiched and fed by the heat roller 11 and the backup roller 12, control is performed on the amount of oil applied by the oil web 10 so as not to increase the amount of oil on the surface of heat roller 11.

While the continuous web is being fed, the continuous web 6 is in contact with the heat roller 11. Therefore, the oil on the heat roller 11 is adhered onto the continuous web 6 and gradually consumed. On the other hand, before the continuous web is fed, the continuous web 6 is not in contact with the heat roller 11. Therefore, no oil is consumed by the continuous web 6. The control section 206 can control the amount of oil supplied to the oil web 10 and the feed of the oil web 10. However, it may be difficult to promptly increase the amount of the oil 18 having been supplied to the oil web 10 only when the web feed is stopped and promptly increase the amount of oil supplied to the oil web 10 as well. Namely, in the oil application amount control, the following capability of applying oil amount is limited.

On the other hand, when the printing is started, a large amount of oil 18 is temporarily supplied from the oil web 10. On the other hand, an excessive amount of oil is adhered (applied) to the continuous web 6 (especially adhesion pressure bonding continuous web 6p) may degrade the pressure bonding capability. To avoid the problem, before the sheet feed is started, the control section 206 causes the stepping motor 23 to rotate so that the blade section 31 is in contact with the heat roller 11 to control (temporarily reduce) the oil amount adhered to the surface of the heat roller 11. By temporarily removing the oil, when the sheet feed of the adhesion pressure bonding continuous web 6p is started (the printing of the adhesion pressure bonding continuous web 6p is started), an excessive amount of oil may not be applied to the surface of the adhesion pressure bonding continuous web 6p.

However, even in a case where the continuous web is fed, if the blade section 31 continues to press the heat roller 11, the amount of oil on the surface of the heat roller 11 may be insufficient, which may cause the degrade of the mold releasability between the heat roller and toner on the heat roller 11 and the adhesion of toner to the surface of the heat roller 11. To avoid the problem, during the period when the amount of oil on the heat roller 11 may be insufficient, the control section 206 performs control to gradually reduce the pressing force applied from the blade section 31 to the heat roller 11. After the period is elapsed, the control section 206 performs control to completely separate the blade section 31 from the heat roller 11, so that the amount of oil on the heat roller 11 can be increased.

### Normal Printing

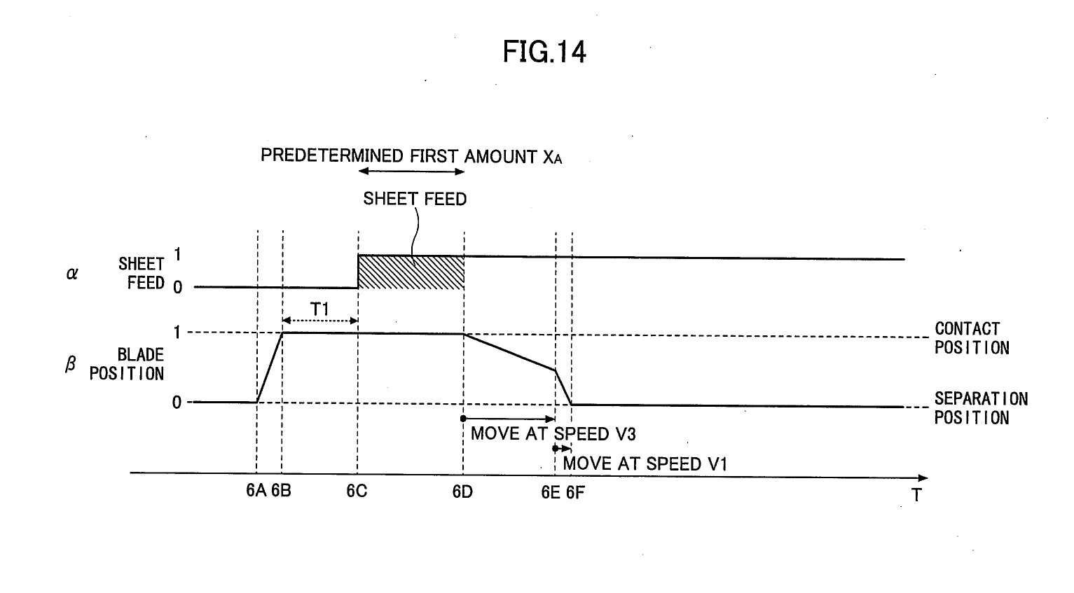

Next in normal printing, a relationship between the blade section 31 and the sheet feed is described. FIG. 14 is a time chart illustrating a relationship between the sheet feed and a blade position. Specifically, a part “α” of FIG. 14 illustrates the sheet feed, and a part “β” of FIG. 14 illustrates the position of the blade section 31. In the part “α” of FIG. 14, a value “1” denotes where the continuous web 6 is being sandwiched and fed by the heat roller 11 and the backup roller 12 (hereinafter “sandwich feed”). On the other hand, a value “0” denotes where the continuous web 6 is not being in the sandwich feed.

Further, in the part “β” of FIG. 14, a value “1” denotes where the blade section 31 is in contact with the heat roller 11. On the other hand, a value “1” denotes where the blade section 31 is separated from the heat roller 11. Further, the lateral axis denotes time T. Further, in the following description, the term “contact position” refers to a position of the blade section 31 where the blade section 31 is in full press contact with the heat roller 11. The term “separation position” refers to a position of the blade section 31 where the blade section 31 is completely separated from the heat roller 11.

First, before printing is performed on the continuous web 6, the blade section 31 is disposed at the separation position which is the initial position of the blade section 31. After the printing is started, at timing 6A (see in FIG. 14), the control section 206 performs control to start moving the blade section 31 to the contact position.

In the next timing 6B, the heat roller 11 rotates while being separated from the backup roller 12 (i.e., the continuous web 6 is not being in the sandwich feed). In this state, the blade section 31 is in contact with the heat roller 11, so that the removal of the excessive oil on the surface of the heat roller 11 is started, the excessive oil being supplied by the oil web 10.

Then, at timing 6C which is after a predetermined first time period T1 has passed since timing 6B, the heat roller 11 is in press contact with the backup roller 12, so that the continuous web 6 is in the sandwich feed while the toner image on the continuous web 6 is being heated and pressed to be fixed on the continuous web 6. Herein, the predetermined first time period T1 is a sufficient time period to adjust the amount of oil 18 on the surface of the heat roller 11 so as to be an appropriate amount of oil. Herein, the appropriate amount of oil may be determined based on various surrounding conditions such as the printing speed, the width of the continuous web, the type of oil, the fixing temperature, the material of the continuous web and the like. Therefore, a table in which the surrounding conditions are associated with the corresponding appropriate amount of oil adapted to the surrounding conditions is stored in the main memory 312 or the like. The control section 206 determines the appropriate amount of oil corresponding to the current printing speed, the width of the continuous web, the type of oil, the fixing temperature, the material of the continuous web and the like based on the table. Further, the control section 206 measures (determines) the predetermined first time period T1 in a manner such that the amount of oil 1B on the surface of the heat roller 11 is the same as the determined appropriate amount of oil. Further, the appropriate amount of oil may be determined in advance for each of the combinations of the parameters in the table. Further, the predetermined first time period T1 may be determined in advance for each of the combination of the parameters in a table, so that the control of the oil control blade 21 may be performed based on the value obtained from the table in which the predetermined first time period T1 is determined for each combination of the parameters.

Then, at timing 6D when an amount of the sandwich feed reaches a previously specified predetermined first amount X_{A} since timing 6C, the control section 206 performs control to move the blade section 31 to the separation position at a third speed V3. This movement is performed by taking a sufficient time period while the removed oil removed by the blade section 31 is elongated into a thin layer oil and returned to the surface of the heat roller 11 by the blade section 31. The movement of the blade section 31 to the separation position is described in more detail. The blade section 31 is in press contact with the heat roller 11. Therefore, the header part of the blade section 31 and the corresponding part of the surface of the heat roller 11 are somewhat deformed. Therefore, the blade section 31 cannot be separated from the heat roller 11 not suddenly but gradually. This is because, oil is accumulated at a connection part where the blade section 31 is in contact with the heat roller 11. As the distance between the blade section 31 and the heat roller 11 is increased (open), the oil is gradually applied to the surface of the rotating heat roller 11 (i.e., the temporarily removed oil is returned to the surface of the heat roller 11). Further, the predetermined first amount X_{A} is the feed amount of the continuous web 6 which is necessary until the amount of oil on the surface of the heat roller 11 becomes stable from when the printing is started. Therefore, the predetermined first amount X_{A} may vary depending on the width of the continuous web 6 to be fed and the feeding speed of the continuous web 6. Herein, the stable oil amount is determined in advance.

Further, the hatching part in FIG. 14 denotes that the continuous web 6 is fed at the predetermined first amount X_{A}.

Next, at timing 6E, when the control section 206 confirms (determines) that the blade section 31 is separated from the heat roller 11, to reduce the degradation of the throughput, the control section 206 increases the separating (movement) speed of the blade section 31 from the heat roller 11 from the third speed V3 to a first speed V1. Herein, it is assumed that the third speed V3<the first speed V1. Further, preferably, the first speed V1 is determined so that, in the first speed V1, no oil adhered to the blade section 31 is jumped (moved) to the surface of the heat roller 11 or adhered to the continuous web 6. Then, at timing 6F, the blade section 31 is moved to the separation position and stopped.

### Embodiment 2-1

### Intermittent Printing

Next, intermittent printing in a first embodiment is described. The intermittent printing refers to printing in which short-term printing and non-printing (i.e., printing is being stopped) are (alternately) repeated in addition to normal printing. In other words, in the intermittent printing, the sandwich feed in which the continuous web 6 is sandwiched and fed by the heat roller 11 and the backup roller 12 and non-feeding of the continuous web 6 (i.e., the sheet feed is being stopped) are (alternately) repeated. In the following, it is assumed that one sandwich feed corresponds to a feed amount X1 that is the feed amount of the continuous web 6 and that is less than the above-described predetermined first amount X_{A} (i.e., a short feed amount). Further, in the following, the term “feed process” refers to where the continuous web is fed in a feed amount X1 which is less than the predetermined first amount X_{A}; and the term “feed stop process” refers to where the “feed process” is being stopped.

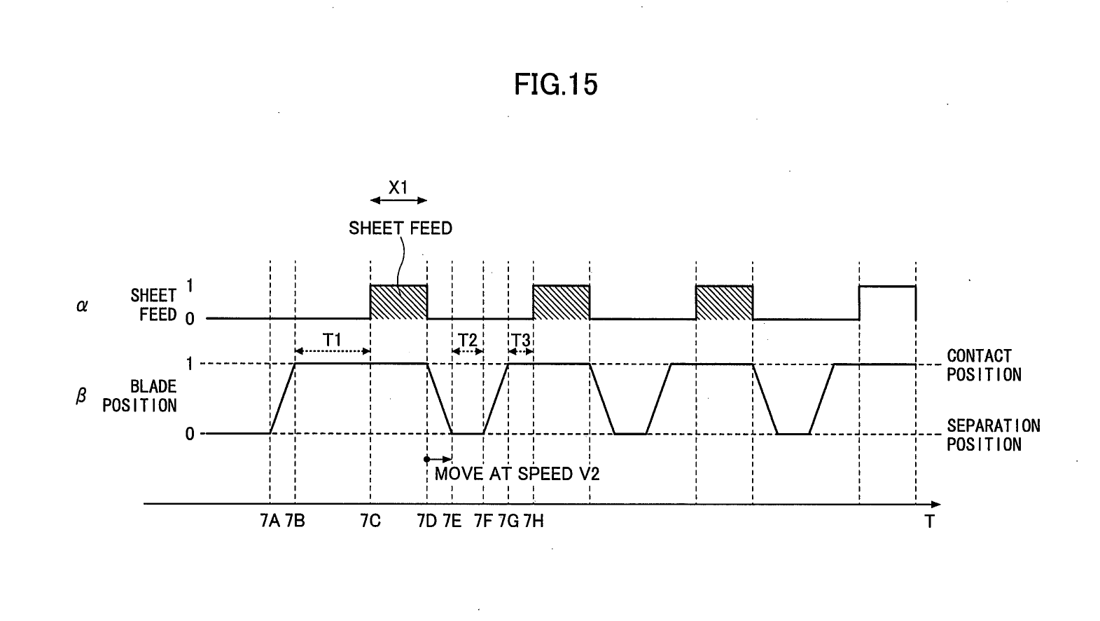

FIG. 15 is a time chart illustrating another relationship between the sheet feed and the blade position of the blade section 31 in the intermittent printing. The operations at timings 7A, 7B, and 7C in FIG. 15 are similar to the operations at timings 6A, 6B, and 6C, respectively. Therefore, the repeated descriptions thereof are herein omitted.

At timing 7D, the sheet feed of the continuous web 6 is stopped in a feed amount of the sandwich feed, the feed amount corresponding to a feed amount X1 which is less than the predetermined first amount X_{A}, the control section 206 starts control at the timing of the feeding stop to move the blade section 31 to the separation position (i.e., to separate the blade section 31 from the heat roller 11) at a second speed V2. As described above, the control section 206 starts control at the timing of the feeding stop (i.e., at timing 7D) to separate the blade section 31 from the heat roller 11.

In the above description with reference to FIG. 15, the separation of the blade section 31 from the heat roller 11 is started at the timing when the feed stop process is started. However, the separation of the blade section 31 from the heat roller 11 may be started at a timing close to when the feed stop process is started.

Then, at timing 7F which is after a predetermined second time period T2 has passed since timing 7E after the blade section 31 has moved to the separation position, the control section 206 performs control to start moving the blade section 31 to the contact position (i.e., to move the blade section 31 to approach the heat roller 11). In this case, to reduce the degradation of the throughput, it is preferable that the predetermined second time period T2 is determined so as to correspond to a time period during which the heat roller 11 rotates one revolution. Then, at timing 7G, the blade section 31 is in contact with the heat roller 11.

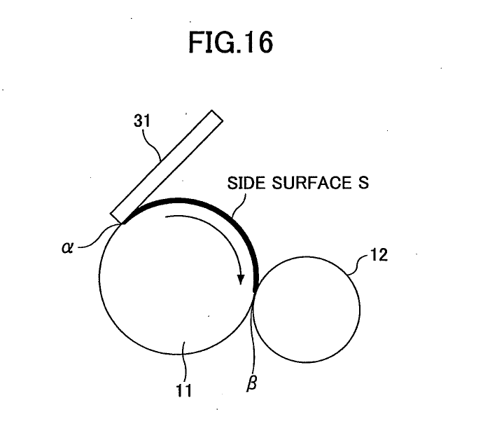

Then, at timing 7H which is after a predetermined third time period T3 has passed since timing 7G, the feed process (namely, the sandwich feed of the continuous web 6) is started again. Next, the predetermined third time period T3 is described with reference to FIG. 16. In FIG. 16, the position “α” refers to the position where the blade section 31 is in contact with the heat roller 11 at the timing when the movement of the blade section 31 to the contact position is completed (i.e., at the moment when the movement is finished). Further, the position “β” refers to the position where the heat roller 11 is in press contact with the backup roller 12 at the timing when the movement of the blade section 31 to the contact position is completed. Further, the side surface “S” refers to a side surface of the heat roller 11, the side surface being depicted in a bold line from the position “α” to the position “β” in the rotation direction of the heat roller 11. The predetermined third time period T3 may be determined so as to be equal to a time period required to temporarily remove at least the oil amount on the side surface “S” by the blade section 31 at the position “α”, the oil amount on the side surface “S” being supplied assuming that no blade is being used. Further, the predetermined third time period T3 may be determined so as to be equal to a time period required to temporarily remove at most the oil amount on the entire surface of the heat roller 11 by the blade section 31 at the position “α”, the oil amount on the entire surface of the heat roller 11 being supplied assuming that no blade is being used. Further, when the blade section 31 is in full press contact with the heat roller 11, most of oil may be temporarily removed. Therefore, the predetermined third time period T3 substantially corresponds to the time period when the heat roller 11 rotates from the position “α” to the position “β”. Similar to the predetermined first time period T1 as described above, the predetermined third time period T3 may be determined based on a table prepared in advance.

Further, the predetermined third time period T3 may be determined to be a sufficient time period necessary to adjust (remove) the oil 18 on the surface of the heat roller 11 to an appropriate amount.

In the following, while the feed process in which the feed amount of the sandwich feed of the continuous web 6 is less than the predetermined first amount X_{A} is repeated, the fixing device performs the operations described with reference to the timings 7C through 7H.

In the fixing device according to the second embodiment of the present invention, during the time period from when the feed stop process is started (at timing 7D) to timing 7G, the blade section 31 is not in contact with the heat roller 11 and the continuous web 6 is not sandwiched and fed by the heat roller 11 and the backup roller 12. Therefore, no oil on the surface of the heat roller 11 may be removed during the time period. On the other hand, the oil web 10 always continues to apply oil to the surface of the heat roller 11, during the time period from timing 7D to timing 7G, the amount of oil on the surface of the heat roller 11 is continuously increased. Therefore, shortage of oil on the heat roller 11 may not occur, thereby preventing the degradation of the mold releasability between the heat roller 11 and toner on the heat roller 11 and the adherence of toner to the surface of the heat roller 11.

Further, during the time period from timing 7G to timing 7H, the blade section 31 is in press contact with the heat roller 11. Therefore, a certain amount of oil applied on the surface of the heat roller 11 may be removed so that a necessary amount of oil may be remained. Therefore, the fixing device according to this embodiment of the present invention may adjust the amount of oil applied to the surface of the heat roller 11 at an appropriate amount.

### Embodiment 2-2

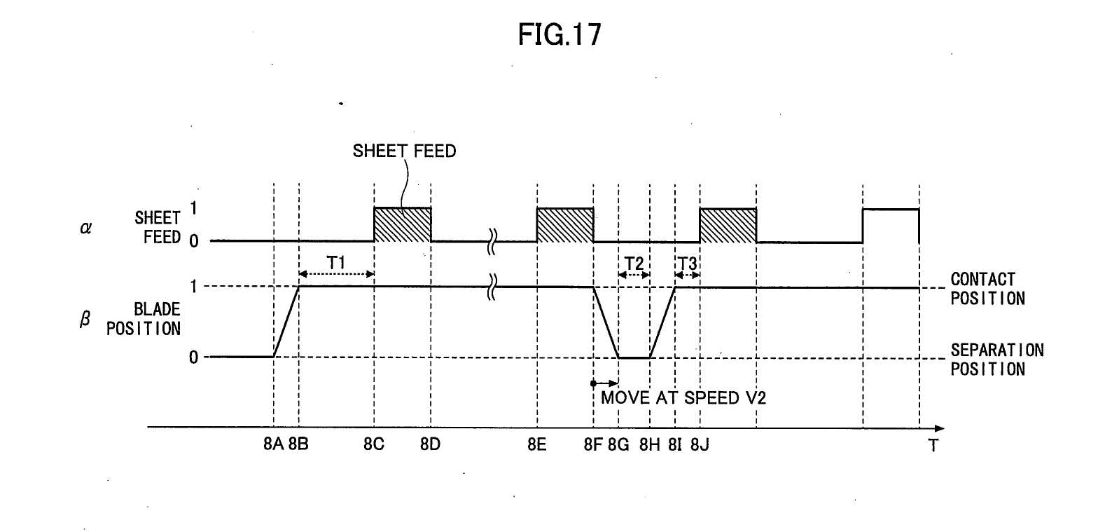

Next, intermittent printing in a second embodiment is described. FIG. 17 is a time chart illustrating another relationship between the sheet feed and the blade position of the blade section 31 in another intermittent printing. The operations at timings 8A, 8B, and 8C in FIG. 17 are similar to the operations at timings 6A, 6B, and 6C in FIG. 14 and the operations at timings 7A, 7B, and 7C in FIG. 15, respectively. Therefore, the repeated descriptions thereof are herein omitted.

At timing 8D, even when the sheet feed of the continuous web 6 is stopped in a feed amount of the sandwich feed, the feed amount corresponding to a feed amount X1 which is less than the predetermined first amount X_{A}, the control section 206 continues to control to cause the blade section 31 to remain at the contact position and stores the feed amount (sandwich feed amount) X1 in the main memory 312 or the auxiliary memory 313 (see FIG. 6).

Then, the control section 206 performs control to start the sheet feed again, stops the sheet feed in a sandwich feed amount X2 which is less than the predetermined first amount X_{A}, and adds the sandwich feed amount X2 to the stored feed amount so far in the memory. The sandwich feed amount X2 is not illustrated in FIG. 17 because the sandwich feed amount X2 is omitted in the omitted part between timing 8D and timing 8E. In the same manner, sandwich feed amounts X3, X4, . . . are calculated.

Next, at timing 8E, the control section 206 performs control to start the “yth” sheet feed again, and stops the sheet feed (at timing 8F) in a sandwich feed amount Xy which is less than the predetermined first amount X_{A}. Then, the control section 206 compares the accumulated sandwich feed amount X_{SUM}=X1+X2+ . . . +Xy with a predetermined second amount X_{B}. When determining that X_{SUM}≧predetermined second amount X_{B}, the control section 206 performs control to start moving the blade section 31 to the separation position at the second speed V2 at timing 8F when the last sheet feed is stopped (i.e., when the accumulated sandwich feed amount X_{SUM} of the continuous web 6 is equal to or greater than the predetermined second amount X_{B}) or at a timing close to timing 8F. Herein, the predetermined second amount X_{B} is the maximum amount of the feed amount corresponding to a state where the oil 18 remains on the surface of the heat roller 11 in a manner such that toner can be appropriately fixed even when the blade section 31 is continuously in contact with the heat roller 11, and is determined in advance. Namely, in the state where X_{SUM}≧predetermined second amount X_{B}, the oil on the surface of the heat roller 11 may be insufficient and toner may not be appropriately fixed. Determination of the predetermined second amount X_{B} is described below.

Then, during the time period from the timing when determining that X_{SUM}≧predetermined second amount X_{B} (at timing 8F) to timing 8I, the blade section 31 is separated from the heat roller 11. Therefore, during the time period from timing 8F to timing 8I, the amount of oil on the surface of the heat roller 11 is continuously increased. Then, at timing 8J which is after a predetermined third time period T3 has passed since timing 8I, the sheet feed process is performed again.

Further, in the example of FIG. 17, during the time period from timing 8F to timing 8J, the same processes (i.e., the processes from timing 7D to timing 7H in FIG. 15) are performed as the processes in the first embodiment. However, alternatively, during the time period from timing 8F to timing 8J, the same processes as the processes from timing 8C to timing 8F may be performed.

Further, when determining that X_{SUM}≧predetermined second amount X_{B}, the control section 206 performs control to delete the accumulated sandwich feed amount X_{SUM} stored in the main memory 312 or the auxiliary memory 313.

In the fixing device according to the second embodiment of the present invention, during the accumulated sandwich feed amount X_{SUM} is less than the predetermined second amount X_{B}, the blade section 31 is controlled to be continuously in press contact with the heat roller 11. Then, when determining that the accumulated sandwich feed amount X_{SUM} is equal to or greater than the predetermined second amount X_{B}, the blade section 31 is controlled to be separated from the heat roller 11. By doing in this way, it may become possible to appropriately adjust the amount of oil on the surface of the heat roller 11. Further, in the fixing device according to the second embodiment of the present invention, it may become possible to reduce the number of times of moving the blade section 31 when compared with the corresponding number in the fixing device according to the first embodiment of the present invention. Therefore, it may become possible to prevent the degradation of the throughput.

### Relationship Between First Speed V1 and Second Speed V2

Further as described with reference to FIG. 14, the first speed V1 refers to the fastest speed among the various speeds to be set to separate the blade section 31 from the heat roller 11 when the feed amount of the continuous web 6 exceeds the predetermined first amount X_{A}. On the other hand, the second speed V2 refers to the speed which is set to separate the blade section 31 from the heat roller 11 when the feed stop process is started (at timing 7D in FIG. 15 and timing 8F in FIG. 17) in a case where the feed process and the feed stop process are repeatedly performed. Preferably, the second speed V2 is greater (faster) than the first speed V1. This is because, by setting the second speed V2 faster than the first speed, it may become possible to reduce the time period necessary to start the next sheet feed, and prevent the degradation of the throughput. Also, even if the oil is jumped from the blade section 31 to the surface of the heat roller 11, the ink may not be adhered to the continuous web 6 because the sheet feed is being stopped.

### Method of Determining Predetermined Second Amount X_{B}

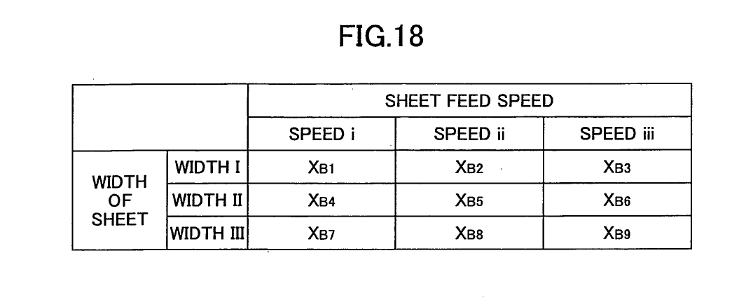

Further, the determining predetermined second amount X_{B} is determined based on the width of the continuous web 6 to be fed and the feeding speed of the continuous web 6. As illustrated in FIG. 18, the most appropriate predetermined second amounts X_{B} for each of the conditions of the width of the continuous web 6 to be fed and the feeding speed of the continuous web 6 is determined in advance by conducting experiments. For example, when the value of the width of the continuous web is I and the value of the sheet feeding speed is i, X_{B}=X_{B}1. When the most appropriate predetermined second amount X_{B} is determined, a user inputs the determined predetermined second amount X_{B} via the input section 317. Then, the input predetermined second amount X_{B} is stored in the main memory 312 or the auxiliary memory 313, so that the above-described fixing device according to the second embodiment of the present invention is provided.

Further, in the main memory 312 or the auxiliary memory 313, the table illustrated in FIG. 18 is stored in advance. The calculation section 2062 (see FIG. 6) in the control section 206 calculates the predetermined second amount X_{B} based on the table based on the width of the continuous web and the sheet feeding speed that are set. For example, when the value of the width of the continuous web is I and the value of the sheet feeding speed is i, the calculation section 2062 determines predetermined second amount X_{B}1 as X_{B}.

Further, the width of the continuous web may be input by a user via the input section 317 (see FIG. 6). Otherwise, by using a known method, the width of the continuous web may be obtained by using a sheet width detection sensor (not shown) for detecting the width of the continuous web. The calculation section 2062 may use the width of the continuous web based on the input by a user or the width calculated by the calculation section 2062. Further, the sheet feeding speed may be input by a user via the input section 317. Otherwise, the calculation section 2062 may obtain the sheet feeding speed based on the sheet feeding speed that has been set.

### Third Embodiment

Next, a third embodiment of the present invention is described. In the third embodiment, the configuration of the fixing device and the image forming apparatus (especially a part where contact angle of the blade section 31 is described) described in the first embodiment is integrated into the configuration of the fixing device and the image forming apparatus (especially a part where control is performed to contact and separate between the blade section 31 and the heat roller 11) described in the second embodiment. In the fixing device or the image forming apparatus according to the third embodiment of the present invention, when compared with the fixing devices and the image forming apparatuses according to the first and the second embodiments of the present invention, it may become possible to adjust the amount of oil on the surface of the heat roller 11 more appropriately. As a result, it may become possible to fix toner without degrading the pressure bonding capability even when the adhesion pressure bonding continuous web 6p or the like is used.

According to an embodiment of the present invention, it may become possible to provide a fixing device fixing toner without degrading the pressure bonding capability even when the adhesion pressure bonding continuous web 6p or the like is used, and provide an image forming apparatus having the fixing device.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A fixing device comprising:
a first roller facing an image forming surface of a recording medium on which an image is formed;
a second roller that is provided in a manner such that the second roller can be in contact with and separated from the first roller and that faces a surface opposite to the image forming surface of the recording medium;
a lubricant application unit applying lubricant to a surface of the first roller and wipes the surface of the first roller;
a lubricant supply unit supplying lubricant to the lubricant application unit;
a lubricant control blade disposed at a position and being in contact with and separated from the surface of the first roller, the position being disposed on a downstream side in a rotating direction of the first roller from a position where the lubricant application unit is in contact with the first roller and being disposed on an upstream side in the rotating direction of the first roller from a position where the second roller is in contact with and separated from the first roller, wherein
the recording medium on which the image is formed is sandwiched and fed between the first roller and the second roller so as to fix the image onto the recording medium,
a contact angle θ of the lubricant control blade relative to the first roller is in a range between 35 degrees and 43 degrees, and
a linear pressure F applied from the lubricant control blade to the first roller is in a range from 0.35 N/cm to 0.5 N/cm.

2. The fixing device according to claim 1, wherein
the first roller includes a core and a surface coating layer formed on the core, the surface coating layer being made of fluorine based resin having a thickness in a range from 10 μm to 50 μm, and
a rubber hardness Hs of the lubricant control blade is in a range from 60° to 80°.

3. The fixing device according to claim 1, wherein
the first roller includes a core and a surface coating layer formed on the core, the surface coating layer being made of fluorine based resin having a thickness equal to or greater than 70 μm, and
a rubber hardness Hs of the lubricant control blade is in a range from 70° to 90°.

4. The fixing device according to claim 1, wherein
the first roller includes a core, a surface coating layer, and a rubber layer, the surface coating layer being made of fluorine based resin having a thickness equal to or greater than 10 μm, the rubber layer being provided between the core and the surface coating layer and having a thickness equal to or greater than 150 μm, and
a rubber hardness Hs of the lubricant control blade is in a range from 70° to 90°.

5. The fixing device according to claim 1, wherein
an outer diameter of the first roller is equal to or greater than 70 mm.

6. The fixing device according to claim 1, wherein
the recording medium is an adhesion pressure bonding continuous web.

7. The fixing device according to claim 1, further comprising:
a control unit causing the lubricant control blade to be separated from the first roller at a timing or at a timing close to when a feed stop process is started in a case where a feed process and a feed stop process are alternately repeated, the feed process being a process where the recording medium is sandwiched and fed by the first roller and the second roller in a sandwich feed amount which is less than a predetermined first amount, the feed stop process being a process where the feed process is being stopped.

8. The fixing device according to claim 7, wherein
the control unit causes the lubricant control blade to be in contact with the first roller during a time period from when lubricant is applied to the surface of the first roller to when a next feed process is started.

9. The fixing device according to claim 1, further comprising:
a control unit causing the lubricant control blade to be separated from the first roller at a timing or at a timing close to when an accumulated feed amount of the recording medium is equal to or greater than a predetermined second amount while the lubricant control blade is being in contact with the first roller in a case where a feed process and a feed stop process are alternately repeated, the feed process being a process where the recording medium is sandwiched and fed by the first roller and the second roller in a sandwich feed amount which is less than a predetermined first amount, the feed stop process being a process where the feed process is being stopped.

10. The fixing device according to claim 9, wherein
the control unit causes the lubricant control blade to be in contact with the first roller during a time period from when lubricant is applied to the surface of the first roller to when a next feed process is started.

11. The fixing device according to claim 9, further comprising:
an input unit through which the predetermined second amount, is input.

12. The fixing device according to claim 7, wherein
when a first speed refers to a fastest speed among various speeds to be set to separate the lubricant control blade from the first roller when the sandwich feed amount of the recording medium is equal to or greater than the predetermined first amount, and when a second speed refers to a speed which is set to separate the lubricant control blade from the first roller when the feed process and the feed stop process are repeatedly performed, the second speed is greater than the first speed.

13. A fixing device comprising:
a first roller facing an image forming surface of a recording medium on which an image is formed;
a second roller that is provided in a manner such that the second roller can be in contact with and separated from the first roller and that faces a surface opposite to the image forming surface of the recording medium;
a lubricant application unit applying lubricant to a surface of the first roller and wipes the surface of the first roller;
a lubricant supply unit supplying lubricant to the lubricant application unit;
a lubricant control blade disposed at a position and being in contact with and separated from the surface of the first roller, the position being disposed on a downstream side in a rotating direction of the first roller from a position where the lubricant application unit is in contact with the first roller and being disposed on an upstream side in the rotating direction of the first roller from a position where the second roller is in contact with and separated from the first roller; and
a control unit causing the lubricant control blade to be separated from the first roller at a timing or at a timing close to when a feed stop process is started in a case where a feed process and a feed stop process are alternately repeated, the feed process being a process where the recording medium is sandwiched and fed by the first roller and the second roller in a sandwich feed amount which is less than a predetermined first amount, the feed stop process being a process where the feed process is being stopped.

14. The fixing device according to claim 13, wherein
the control unit causes the lubricant control blade to be in contact with the first roller during a time period from when lubricant is applied to the surface of the first roller to when a next feed process is started.

15. The fixing device according to claim 13, wherein
when a first speed refers to a fastest speed among various speeds to be set to separate the lubricant control blade from the first roller when the sandwich feed amount of the recording medium is equal to or greater than the predetermined first amount, and when a second speed refers to a speed which is set to separate the lubricant control blade from the first roller when the feed process and the feed stop process are repeatedly performed, the second speed is greater than the first speed.

16. A fixing device comprising:
a first roller facing an image forming surface of a recording medium on which an image is formed;
a second roller that is provided in a manner such that the second roller can be in contact with and separated from the first roller and that faces a surface opposite to the image forming surface of the recording medium;
a lubricant application unit applying lubricant to a surface of the first roller and wipes the surface of the first roller;
a lubricant supply unit supplying lubricant to the lubricant application unit;
a lubricant control blade disposed at a position and being in contact with and separated from the surface of the first roller, the position being disposed on a downstream side in a rotating direction of the first roller from a position where the lubricant application unit is in contact with the first roller and being disposed on an upstream side in the rotating direction of the first roller from a position where the second roller is in contact with and separated from the first roller; and
a control unit causing the lubricant control blade to be separated from the first roller at a timing or at a timing close to when an accumulated feed amount of the recording medium is equal to or greater than a predetermined second amount while the lubricant control blade is being in contact with the first roller in a case where a feed process and a feed stop process are alternately repeated, the feed process being a process where the recording medium is sandwiched and fed by the first roller and the second roller in a sandwich feed amount which is less than a predetermined first amount, the feed stop process being a process where the feed process is being stopped.

17. The fixing device according to claim 16, wherein
the control unit causes the lubricant control blade to be in contact with the first roller during a time period from when lubricant is applied to the surface of the first roller to when a next feed process is started.

18. The fixing device according to claim 16, further comprising:
an input unit through which the predetermined second amount is input.

19. An image forming apparatus comprising:
a photosensitive body;
a charge device charging a surface of the photosensitive body;
an exposure device forming a latent image on the charged surface of the photosensitive body;
a development device developing the latent image to form a toner image;
a transfer device transferring the toner image onto a recording medium; and
a fixing device passing the recording medium on which the toner image is transferred between a first roller and a second roller so as to fix the toner image onto the recording medium by heating and pressing the recording medium, wherein
the fixing device is a fixing device according to claim 1.
